(19) United States
(12) Patent Application Publication
(10) Pub. No.: US 2018/0014555 A1
(43) Pub. Date: Jan. 18, 2018

(54) BREWER'S SPENT-GRAIN BASED PROTEIN POWDER

(71) Applicant: ZEA10, LLC, Eden Prairie, MN (US)

(72) Inventors: Ian Mackay, Eden Prairie, MN (US); Karl Greden, Minneapolis, MN (US); J. David Mingus, New Hope, MN (US); Kevin Toboja, Minneapolis, MN (US)

(21) Appl. No.: 15/651,389

(22) Filed: Jul. 17, 2017

Related U.S. Application Data
(60) Provisional application No. 62/362,987, filed on Jul. 15, 2016.

(51) Int. Cl. A23J 1/12

(52) U.S. Cl. CPC A23J 1/12; A23L 33/115; A23L 33/17; A23L 7/20

(57) ABSTRACT

Brewer's spent-grain based protein powder and related methods for using producing protein-enhanced foodstuff. The brewer's spent-grain based protein powders have beneficial properties including low phytic acid content, high PDCAAS value and retention of significant antioxidant properties. The brewer's spent-grain based protein powders are highly soluble and thus are easily wetable, readily dispersable and blendable in concentrations of up to 50% by weight. The brewer's spent-grain based protein powder possesses beneficial sensory characteristics including light color and mild flavor that allow the brewer's spent-grain based protein powder to be used alone or as a protein value enhancer within foods intended for human consumption, companion pet foods and in commercial livestock feeds.

### RELATED APPLICATION

The present application claims the benefit of U.S. Provisional Application No. 62/362,987 filed Jul. 15, 2016, which is hereby incorporated herein in its entirety by reference.

### FIELD OF THE INVENTION

The present invention relates generally to a protein supplement. More specifically, the present invention is directed to a protein supplement that is recovered from brewer's spent-grains that arise during agricultural milling and processing operations.

### BACKGROUND OF THE DISCLOSURE

The use of protein powders and supplements is well known in the art. For example, many people utilize protein powder to make beverages or other food stuffs as part of a training regimen to provide additional protein for muscle growth. In addition, people may utilize protein supplements when their daily diet is insufficient to satisfy the human body's daily protein requirements. For instance, elderly persons often fail to consume enough calories and protein and may supplement their requirements with drinks such as, for example, Ensure® available from Abbot Laboratories of Abbot Park, Ill. In addition, individuals with specific diets including vegetarians and vegans that do not allow for the consumption of traditional meat-based protein sources may supplement their diets with protein powders to meet their daily requirements.

Traditionally, protein powders and supplements have generally been whey, soy or casein-based products. Whey and casein proteins are generally recovered as a by-product from dairy production, with whey being isolated from cheese production and casein being isolated from milk. Soy proteins are isolated from soybeans. While whey, soy and casein-based protein powders and supplements are used to successfully provide beneficial amounts of protein, it would be advantageous to have protein powders and supplements from other sources that are capable of providing beneficial amounts of protein with differing properties including flavor, solubility and nutritional make-up.

### SUMMARY OF THE DISCLOSURE

Representative embodiments of the present invention include protein powders and supplements that are recovered from brewer's spent-grains including rice, oats, wheat, corn, sorghum, millet and barley. Protein powders of the present invention generally have beneficial properties for mixing with liquids including the protein powders being highly soluble, easily wetable, readily dispersable and blendable. In addition, protein powders from brewer's spent-grains are naturally low in their phytic acid content. Protein powders from brewer's spent-grains also retain significant antioxidant properties.

In one aspect, the present invention is directed to a brewer's spent-grain based protein powder. The brewer's spent-grain can include rice, oats, wheat, corn, sorghum, millet and barley. Generally, the brewer's spent-grain based protein powder will have an average molecular weight of about 5,000 Daltons though the process for recovering the brewer's spent-grain protein powder can be tailored to adjust the average molecular weight, either higher or lower, for specific uses and applications including tailoring a taste profile of the brewer's spent-grain based protein powder. The brewer's spent-grain based protein powder has reduced phytic acid (phytate) content than found in the source grain due to hydrolyzation and removal of the phytate during the brewing process. The brewer's spent-grain based protein powder is highly soluble, easily wetable, blendable and readily dispersal in both aqueous and oil solutions. The brewer's spent-grain based protein powder is easily soluble in amounts of up to about 50% by weight, and is preferably used in amounts of 30-40% by weight with only minor increases in viscosity at ambient temperature and across a wide range of solution pH. The brewer's spent-grain based protein powder retains significant antioxidant properties. Another advantage of the brewer's spent-grain based protein powder of the present invention is that it possesses a high PDCAAS (Protein Digestibility Corrected Amino Acid Score) value as compared to conventional grain based ingredients and can be used to extend or enhance the protein value of other low and medium value proteins. In addition, the brewer's spent-grain based protein powder of the present invention includes beneficial sensory characteristics including a pleasant mouth feel and mild flavor that allow the brewer's spent-grain based protein powder to be used alone or as a protein value enhancer within foods intended for human consumption, companion pet foods and in commercial livestock feeds.

In another aspect, the present invention is directed to protein-enhanced foodstuffs that comprise a brewer's spent-grain based protein powder. In some embodiments, the protein-enhanced foodstuff can comprise up to 50% by weight of the protein-enhanced foodstuff, and is preferably used in an amount of 20-40% by weight of the protein-enhanced foodstuff without impacting a flavor profile of the protein-enhanced foodstuff. In some embodiments, the protein-enhanced foodstuff can comprise beverages including, for example, energy drinks, shakes, smoothies, coffee and coffee-based drinks (i.e. latte, mocha, etc.) and teas. In other embodiments, the protein-enhanced foodstuff can comprise muscle building supplements including meal replacement bars and workout drinks. In some embodiments, the protein-enhanced foodstuff can comprise meat substitutes including, for example, meat and meat binder replacements and extruded meat substitutes. In some embodiments, the protein-enhanced foodstuff can comprise coatings and/or bindings for granola, nutrition bars and mueslis. In other embodiments, the protein-enhanced foodstuff can comprise seasonings for the preparation of bases, gravies, soups and sauces. In some embodiments, the protein-enhanced foodstuff can comprise baked goods such as, for example, brownies, cakes, cookies, breads, crackers and the like. In yet other embodiments, the protein-enhanced foodstuff can comprise breakfast products including waffles, pancakes, quick breads, pastries and the like. In some embodiments, the protein-enhanced foodstuff can comprise dairy products such as, for example, yogurts, cheese spreads, cheese based products and the like. In some embodiments, the protein-enhanced foodstuff can comprise cocoa power extender. In some embodiments, the protein-enhanced foodstuff can comprise chocolates, candies and confections. In some embodiments, the protein-enhanced food stuff can comprise carbohydrate based entrees such as pasta (macaroni and cheese), rice and grains. In some embodiments, the protein-enhanced foodstuff can comprise dips, spreads and toppings (hummus).

The components of brewer's spent-grains lend themselves well as potential food products. Resulting proteins are easily soluble with a low phytic acid content. Research has also shown that brewer's spent-grains retain much of their antioxidant properties, suggesting a potential use as an antioxidant nutriceutical. Furthermore, isolated proteins can be isolated to retain a higher or lower molecular weight depending on the desired speed of adsorption. Proteins isolated with a higher adsorption can replace other protein supplements such as whey and soy protein.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a graph of liquid chromatography data demonstrating elution of protein by time for a brewer's spent-grain based protein powder according to a representative embodiment of the present invention.

FIG. 2 is a graph correlating the data contained in FIG. 1 with molecular weight for a brewer's spent-grain based protein powder according to a representative embodiment of the present invention.

FIG. 3 is a graph in which the data contained in FIG. 2 is integrated to demonstrate the amount of protein in each molecular weight range for a brewer's spent-grain based protein powder according to a representative embodiment of the present invention.

FIG. 4 is a graph illustrating viscosity measurements of brewer's spent-grain based protein powder and water with changes in pH according to a representative embodiment of the present invention.

FIG. 5 is a photograph illustrating foaming of a 10% solution of brewer's spent-grain based protein powder according to a representative embodiment of the present invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

A brewer's spent-grain based protein powder according to representative embodiments of the present invention can include brewer's spent-grain from grain sources including, for example, rice, oats, wheat, corn, sorghum, millet and barley. The brewer's spent-grain based protein powder can be recovered and processed as a by-product of a conventional brewing operation, for example, by the process disclosed within United States Patent Publication Nos. 2015/0189900A1, 2016/0194679A1 and 2016/0278402A1, all of which are herein incorporated by reference in their entirety. The brewer's spent-grain based protein powder not only provides an additional revenue source to brewing operations but in addition, possesses various attributes imparted by the brewing and recovery operation which are advantageous for use as a protein supplement.

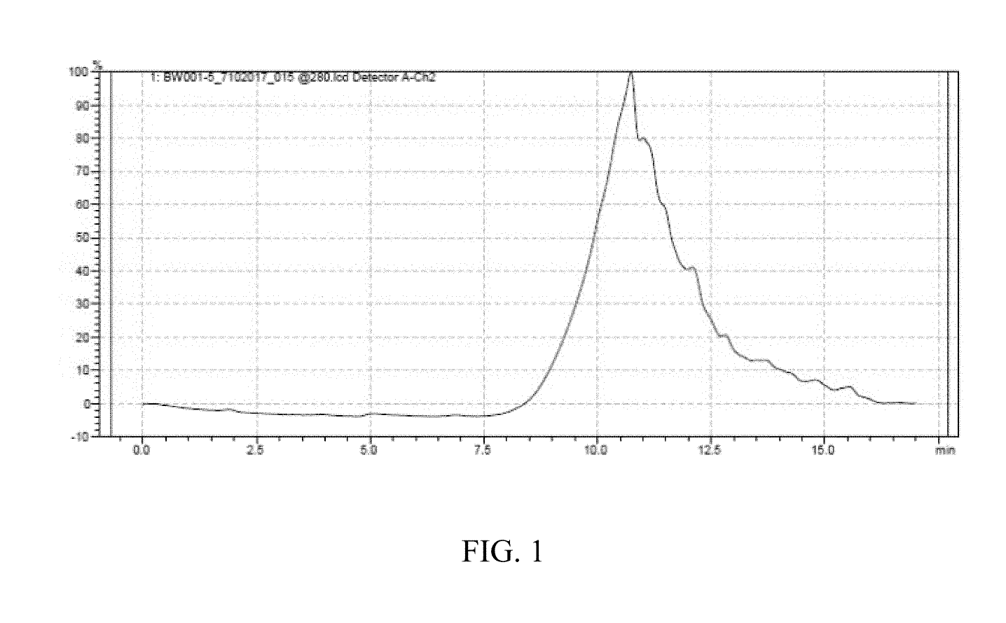

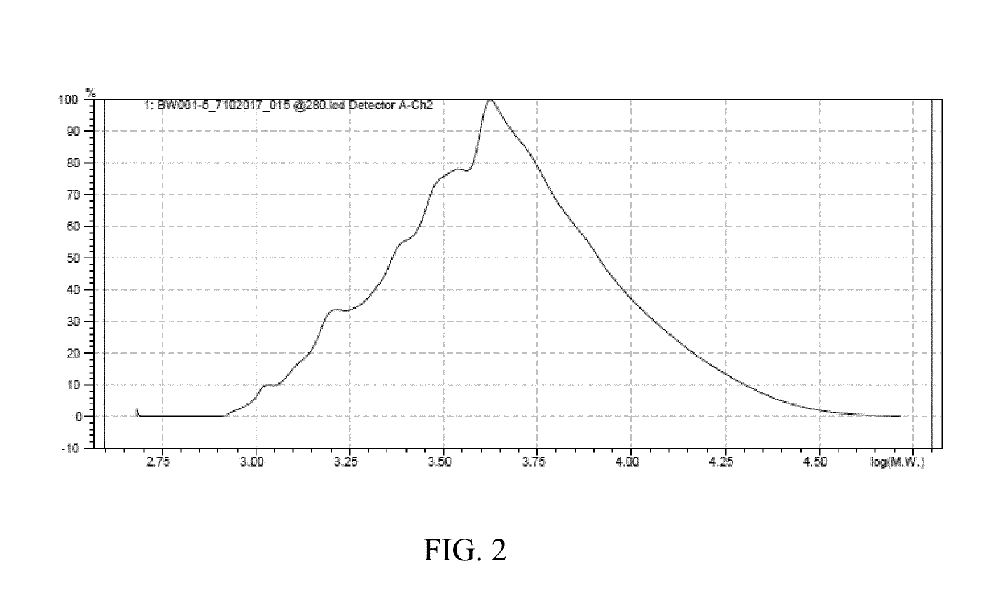

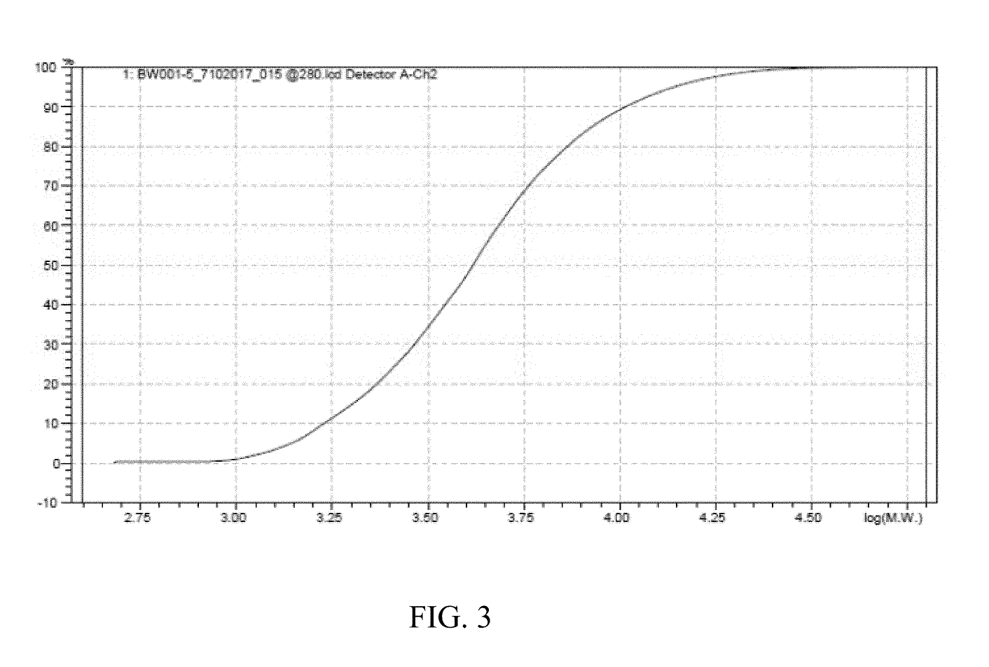

In one representative embodiment of the present invention, the brewer's spent-grain based protein powder can be processed to have an average molecular weight of between about 500 to about 15,000 Daltons. As illustrated in the liquid chromatography data contained with FIGS. 1, 2 and 3, an embodiment of the brewer's spent-grain based protein powder has a primary peak centered at an elution time corresponding to a molecular weight of 4,200 Daltons. In one presently preferred embodiment, the brewer's spent-grain based protein powder is processed to have an average molecular weight of about 5,000 Daltons. At a molecular weight of about 5,000 Daltons, the brewer's spent-grain based protein powder possesses a light-tan appearance which blends well other ingredients and has the ability to enhance color in some products. Furthermore, at an average molecular weight of about 5,000 Daltons, the brewer's spent-grain based protein powder has a mild flavor allowing it to be blended with many products to enhance their protein content. Using the process disclosed in United States Patent Publication Nos. 2015/0189900A1, 2016/0194679A1 and 2016/0278402A1, it is possible to selectively vary the average molecular weight to achieve desired taste profiles by varying hydrolyzation periods. For example, as the molecular weight of the brewer's spent-grain based protein powder is reduced, for example, approaching the lower limit of about 500 Daltons, the taste profile will become more bitter.

Due to the nature of the brewing operation and the recovery process for the brewer's spent-grain based protein powder of the present invention, the brewer's spent-grain based protein powder can also be significantly lower in phytic acid (phytate) content than would be present in typical grain based protein products. During a conventional brewing operation, the phytic acid content is continually reduced. For example, when barley is utilized in the brewing operation, the barley typically has an initial phytic acid content of approximately 1.2% (dry basis). During the malting step, approximately 10-30% of the phytic acid is hydrolyzed. During the mashing step, another 60-90% of the remaining phytic acid is hydrolyzed. When separating the spent barley, approximately 50% of the remaining phytic acid remains within the wort. As such, the brewing operation removes phytic acid to the point that upon recovery of brewer's spent-grain based protein powder from the barley brewer's spent-grains, the phytic acid content in brewer's spent-grain based protein powder is approximately 0.04-0.21% (dry basis), which not only is a significant reduction but is now less than or equal to the phytic acid content of white rice (approximately 0.2% dry basis). As such, the risk of the brewer's spent-grain based protein powder of the present invention contributing to potential phosphorous, iron and zinc related deficiencies is significantly reduced as compared to conventional grain based proteins.

The brewer's spent-grain based protein powder of the present invention also possesses a high PDCAAS (Protein Digestibility Corrected Amino Acid Score) of about 0.7. PDCAAS measures protein quality for human consumption by combining both digestibility characteristics (digestibility score) and amino acid qualities (amino acid score) with a combined PDCAAS value of 1.0 being the highest (highest protein quality for human consumption) and 0 being the lowest (lowest protein quality for human consumption). The brewer's spent-grain based protein powder of the present invention generally has the highest possibly protein digestibility score of 1.0 (typically 0.7-0.8 for grains). The brewer's spent-grain based protein powder of the present invention possesses naturally high levels of glutamine and other branched chain amino acids. The amino acid score for the brewer's spent-grain based protein powder is 0.7 (typically 0.4 to 0.5 for grains) and is generally limited by the lowest essential amino acid, which in the brewer's spent-grain based protein powder is lysine. In some embodiments, the brewer's spent-grain based protein powder of the present invention can include supplemental amounts of pure lysine or other complimentary proteins having an excess of lysine such as, for example, legume proteins (pea, soy, chickpea, cowpea, etc. . . . ) and/or pumpkin seed protein so as to elevate the amino acid score, and correspondingly, the PDCAAS score so as exceed 0.7 and approach 1.0.

The brewer's spent-grain based protein powder of the present invention is highly soluble, easily wetable, readily dispersable and blendable. In addition to having a high PDCAAS score (with an ability to supplement it to an even higher score) and a significantly reduced phytic acid content, the brewer's spent-grain based protein powder retains significant antioxidant properties so as to be potentially advantageous for use as an antioxidant nutriceutical. Combined with the beneficial sensory characteristics including a pleasant mouth feel and mild flavor that allow the brewer's spent-grain based protein powder to be used alone or as a protein value enhancer within foods intended for human consumption, companion pet foods and in commercial livestock feeds, the brewer's spent-grain based protein powder is a highly advantageous protein supplement.

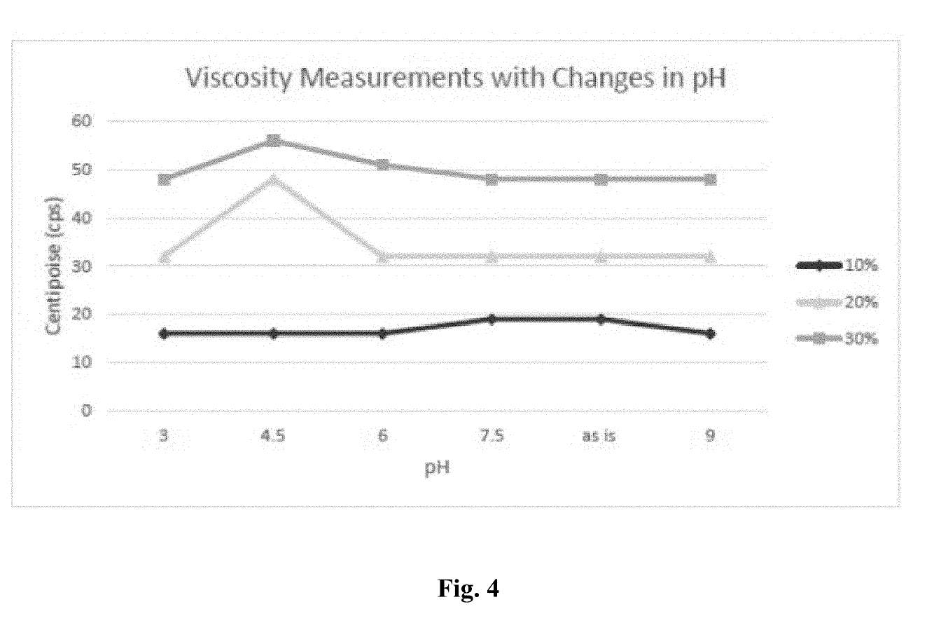

The brewer's spent-grain based protein powder of the present invention possesses a number of characteristics that makes its use advantageous when used to prepare mixed and blended liquid beverages. For example, the brewer's spent-grain based protein powder of the present invention experiences very little change in viscosity over a wide pH range, with one exception as illustrated in Table 1 and the graph of FIG. 4.

TABLE 1
Viscosity of Brewer's Spent-Grain Based Protein Powder in Water

| | | pH | | | | | |
|---|---|---|---|---|---|---|---|
| | Concentration | 3.0 | 4.5 | 6.0 | 7.5 | As Is | 9.0 |
| Viscosity in | 10% solution | 16 cps | 16 cps | 16 cps | 19 cps | 19 cps | 16 cps |
| Water | 20% solution | 32 cps | 48 cps | 32 cps | 32 cps | 32 cps | 32 cps |
| | 30% solution | 48 cps | 56 cps | 51 cps | 48 cps | 48 cps | 48 cps |

At a pH of about 4.5, beverages having more than a 20% concentration of the brewer's spent-grain based protein powder begin to experience precipitation out of the solution. At these concentrations, the brewer's spent-grain based protein powder was found to return back to solution if the pH was lowered to about 3.5. As such, when more concentrated beverages are desired, it may be advantageous to utilize flavors that are more tart or otherwise associated with lower pH values so as to retain the brewer's spent-grain based powder in solution.

Furthermore, the brewer's spent-grain based protein powder of the present invention experienced the expected sedimentation trends with the 30% solution having the highest amount of sedimentation as shown in Table 2 below.

TABLE 2
Sedimentation at Various pH and Concentrations

| | | pH | | | | | |
|---|---|---|---|---|---|---|---|
| | Concentration | 3.0 | 4.5 | 6.0 | 7.5 | As Is | 9.0 |
| Sedimentation - | 10% solution | 4.32% | 4.51% | 2.86% | 2.54% | 2.14% | 2.54% |
| 5 min spin | 20% solution | 7.48% | 8.83% | 4.43% | 4.91% | 3.52% | 3.75% |
| | 30% solution | 10.34% | 18.31% | 7.07% | 6.94% | 5.33% | 5.95% |

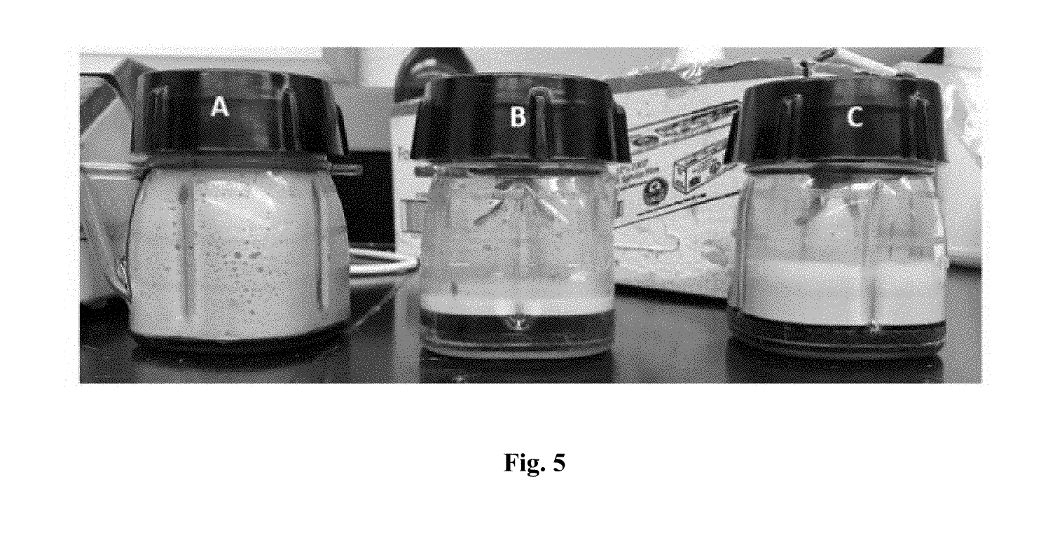

In addition, the brewer's spent-grain based protein powder of the present invention also possesses excellent foaming properties that make it advantageous for use when preparing beverages at a point of use by mixing the powder into water. As seen in FIG. 5, Jar A containing a 10% solution of brewer's spent-grain based powder in water that was blended at the lowest setting for 15 seconds had only a small amount of liquid settle out after one minute while Jars B and C (similar solutions but with Jar B including a drop of antifoam and Jar C including a drop of sunflower lecithin) exhibited little in the way of foam.

Finally, the brewer's spent-grain based protein powder of the present invention lacks any gelation properties and will not form a gel when heated and cooled.

The brewer's spent-grain based protein powder of the present invention can be advantageously used in preparing protein-enhanced foodstuffs without negatively impacting taste and/or aesthetic appearance. In some embodiments, the protein-enhanced foodstuff can comprise beverages, for example, energy drinks, shakes, smoothies, coffee and coffee-based drinks (i.e. latte, mocha, etc.) and teas. In other embodiments, the protein-enhanced foodstuff can comprise muscle building supplements including meal replacement bars and workout drinks. In some embodiments, the protein-enhanced foodstuff can comprise meat substitutes including, for example, meat and meat binder replacements and extruded meat substitutes. In some embodiments, the protein-enhanced foodstuff can comprise coatings and/or bindings for granola, nutrition bars and mueslis. In other embodiments, the protein-enhanced foodstuff can comprise seasonings for the preparation of bases, gravies, soups and sauces. In some embodiments, the protein-enhanced foodstuff can comprise baked goods such as, for example, brownies, cakes, cookies, breads, crackers and the like. In yet other embodiments, the protein-enhanced foodstuff can comprise breakfast products including waffles, pancakes, quick breads, pastries and the like. In some embodiments, the protein-enhanced foodstuff can comprise dairy products such as, for example, yogurts, cheese spreads, cheese based products and the like. In some embodiments, the protein-enhanced foodstuff can comprise cocoa power extender. In some embodiments, the protein-enhanced foodstuff can comprise chocolates, candies and confections. In some embodiments, the protein-enhanced foodstuff can comprise carbohydrate based entrees such as pasta (macaroni and cheese), rice and grains. In some embodiments, the protein-enhanced foodstuff can comprise dips, spreads and toppings (hummus).

Representative examples of protein-enhanced foodstuffs prepared with the brewer's spent-grain based protein powder of the present invention and their recipes/formulations are specifically illustrated below. Throughout these examples, use of the brewer's spent-grain based protein powder did not impact conventional cooking, mixing or preparation times nor did it impact cooking temperatures from conventional recipes.

### Example 1: Protein-Enhanced Banana Bread

| Ingredients | Recipe | | Formula - g | Formula % |
|---|---|---|---|---|
| Bananas | 2 | | 232 | 33.6 |
| Butter, softened | ⅓ | cup | 76 | 11.0 |
| Sugar | ⅔ | cup | 133 | 19.2 |
| Egg | 1 | egg | 60 | 8.7 |
| Vanilla Extract | 1 | tsp | 4 | 0.6 |
| Baking Soda | 1 | tsp | 6 | 0.9 |
| Salt | Pinch | | — | <0.1 |
| All Purpose Flour | 1 | cup | 120 | 17.4 |
| Brewer's Spent- Grain | ⅔ | cup | 60 | 8.7 |
| Based Protein Powder | | | | |

The example recipe for protein-enhanced banana bread sacrifices neither taste nor texture. The protein-enhanced banana bread invention calls for 60 grams of brewer's spent-grain based protein powder, roughly 8.7% mass of the total ingredients, combined with standard banana bread ingredients. An oven can be preheated to 350° F. Flour, brewer's spent-grain based protein powder, baking soda, sugar, and salt are combined in a large bowl. In a separate bowl, wet ingredients such as egg, banana, vanilla and butter are combined. The ingredients are combined, and the wet ingredients are stirred into the dry ingredients, and the mixture is poured into a greased loaf pan. The ingredients are baked for 40 to 50 minutes until inserted toothpick comes out clean. The result is a light, moist and ready to eat bread.

### Example 2: Protein-Enhanced Brownies

| | | |
|---|---|---|
| Ingredients - Control | Recipe | Formula-g |

| | | | |
|---|---|---|---|
| Flour, all purpose | ½ | Cup | 63 |
| Sugar | 1 | cup | 200 |
| Butter | ½ | cup | 113 |
| Eggs | 2 | large | 100 |
| Cocoa Powder-Dutched | ⅓ | cup | 30 |
| Vanilla Extract | 1 | tsp | 4 |
| salt | ½ | tsp | 3 |
| Baking soda | ½ | tsp | 3 |

| | | |
|---|---|---|
| Ingredient - Protein Enhanced | Recipe | Formula-g |

| | | | |
|---|---|---|---|
| Flour, all purpose | ½ | Cup | 63 |
| Sugar | 1 | cup | 200 |
| Butter | ½ | cup | 113 |
| Eggs | 2 | large | 100 |
| Cocoa Powder-Dutched | ⅓ | cup | 30 |
| Brewer's Spent- Grain | | | 60 |
| Based Protein Powder | | | |
| Vanilla Extract | 1 | tsp | 4 |
| salt | ½ | tsp | 3 |
| Baking soda | ½ | tsp | 3 |

The tables above relate to recipes for both protein enhanced and control brownies. Protein enhanced brownies include 60 g of brewer's spent-grain based protein powder added to the control brownie ingredients. In both cases, dry ingredients including flour, cocoa powder, protein concentrate, salt and baking soda are combined in a large bowl. Butter is then heated just above its melting point and combined with eggs and whipped together. Vanilla extract is then added to the eggs and butter and combined with the dry ingredients. The mixture of all ingredients is gently blended until uniform and then baked for 25-35 minutes until and inserted toothpick comes out clean.

### Example 3: Protein Enhanced Coffee Beverages

Control Creamed Mocha

| Ingredient | Formula-g | Formula-% |
|---|---|---|
| Coffee Creamer | 98 | 38.28 |
| Instant Coffee Nescafe | 50 | 19.54 |
| Clasico Dark Roast | | |
| Brown Sugar | 40 | 15.62 |
| Cocoa, Dutch 24% fat | 40 | 15.62 |
| Stevia Sweetener | 16 | 6.25 |
| Cinnamon Flavor | 4 | 1.56 |
| Vanilla Flavor CK ™DryVan | 8 | 3.13 |
| Total | 256 | 100 |

Addition per 12 oz beverage-32 g

Protein Enhanced Creamed Mocha Version 1

| Ingredient | Formula-g | Formula-% |
|---|---|---|
| Brewer's Spent-Grain | 64 | 28.57 |
| Based Protein Powder | | |
| Instant Coffee Nescafe | 51 | 22.77 |
| Clasico Dark Roast | | |
| Brown Sugar | 41 | 18.30 |
| Cocoa, Dutch 24% fat | 40 | 17.86 |
| Stevia Sweetener | 16 | 7.14 |
| Cinnamon Flavor | 4 | 1.79 |
| Vanilla Flavor CK ™DryVan | 8 | 3.57 |
| Total | 224 | 100 |

Addition per 12 oz beverage-28 g

Protein Enhanced Creamed Mocha Version 2

| Ingredient | Formula-g | Formula-% |
|---|---|---|
| Brewer's Spent-Grain | 64 | 20.00 |
| Based Protein Powder | | |
| Coffee Creamer | 98 | 30.62 |
| Instant Coffee Nescafe | 50 | 15.63 |
| Clasico Dark Roast | | |
| Brown Sugar | 40 | 12.5 |
| Cocoa, Dutch 24% fat | 40 | 12.5 |
| Stevia Sweetener | 16 | 5.00 |
| Cinnamon Flavor | 4 | 1.25 |
| Vanilla Flavor CK ™DryVan | 8 | 2.50 |
| Total | 320 | 100 |

Addition per 12 oz beverage-40 g

The tables above relate to caffeinated beverage recipes for both control and protein enhanced coffee beverages. The brewer's spent-grain based protein powder is added to the control ingredients for making the creamed mocha coffee. The ingredients are blended until uniform and then brewed under standard coffee brewing techniques.

| Ingredient | Recipe | | Formula-g | Formula % |
|---|---|---|---|---|
| Quick Oats | 4 | cups | 320 | 45 |
| Puffed Rice | 1 | cup | 30 | 4.2 |
| Vegetable Oil | ¼ | cup | 56 | 8 |
| Sucrose Glaze (Replace with Corn | ¾ | cup | 240 | 34 |

### Example 4: Bread

| Ingredients | Recipe | | Formula - g | Formula % |
|---|---|---|---|---|
| All Purpose Flour | 1¾ | Cup | 219 | 44.69 |
| Brewer's Spent-Grain | ¼ | Cup | 13 | 2.66 |
| Based Protein Powder | | | | |
| Baking Powder | 1 | tsp | 5 | 1.02 |
| Sugar | 1 | Tbsp | 13 | 2.66 |
| Salt | ½ | tsp | 3 | 0.61 |
| Shortening | ¾ | Tbsp | 10 | 2.04 |
| Melted Butter | 2 | Tbsp | 28 | 5.71 |
| Coconut Milk | ½ | Cup | 113 | 23.06 |
| Evap Milk | ¼ | Cup | 63 | 12.86 |
| Shredded Coconut | ¼ | Cup | 23 | 4.69 |
| Total | | | 490 | 100 |

The example above relates to preparation of protein-enhanced bread.

### Example 5: Protein-Enhanced Granola Recipe

| Syrup, Honey, Thick maple | | | | |
|---|---|---|---|---|
| Syrup, other sweet syrups) | | | | |
| Brewer's Spent-Grain | ½ | cup | 30 | 4.2 |
| Based Protein Powder | | | | |
| Cinnamon | 3-4 | tsp | 12 | 1.7 |
| Ginger | 1 | tsp | 3 | 0.4 |
| Vanilla Extract | 3 | tsp | 14 | 2.0 |

The example above relates to preparation of protein-enhanced granola. The cinnamon, ginger, vanilla, oil and sucrose glaze are all combined. Next, the oats, rice and brewer's spent-grain based protein powder are added. The combination is mixed gently until will blended and generally uniform. The combination is spread evenly on a parchment lined baking pan and baked at 300° F. for 20 minutes. The combination is then stirred and placed bake into the oven for baking until dried. The resulting protein-enhanced granola can be cooled and stored in a dry container.

### Example 6: Protein-Enhanced Peanut Butter Bar

| Ingredient | Formula-g | Formula % |
|---|---|---|
| Quick Oats | 20 | 17.39 |
| Crisp Rice | 15 | 13.04 |
| Peanut Butter, Natural | 40 | 34.78 |
| Coconut Palm Sugar | 10 | 8.70 |
| Brewer's Spent-Grain | 20 | 17.39 |
| Based Protein Powder | | |
| Water | 10 | 8.70 |
| | 115 | 100.0 |

| Ingredient | Formula-g | Formula % |
|---|---|---|
| Quick Oats | 20 | 13.7 |
| Crisp Rice | 21 | 14.38 |
| Peanut Butter, Natural | 55 | 37.67 |
| Coconut Palm Sugar | 20 | 13.7 |
| Brewer's Spent-Grain | 20 | 13.7 |
| Based Protein Powder | | |
| Water | 10 | 6.85 |
| | 146 | 100 |

The tables above relate to peanut butter bar recipes enhanced with 20 g of brewer's spent-grain based protein powder. All ingredients except crisp rice are combined and mixed. The crisp rice is then added. The mixture is gently heated to soften and then gently mixed until well blended and uniform. The mixture is then formed into a bar or another shape.

In one version, coconut palm sugar is added alongside water in order to form a syrup. The brewer's spent-grain based protein powder is added and combined to form a paste. Oats and peanut butter are added and blended until the mixture is uniform. Crisp rice is then added and the mixture is gently heated to soften and then mixed until well blended and uniform. The mixture is then formed into a bar or another shape.

### Example 7: Protein-Enhanced Protein Bar

| | | Approx. |
|---|---|---|
| Ingredient | Formula- g | Formula Dried % |
| Quick Oats | 60 | 18.99 |
| Puffed Rice | 30 | 9.49 |
| Dates | 30 | 9.49 |
| Corn Syrup | 24 | 7.60 |
| Brown Sugar | 60 | 18.99 |
| Water | 16 | 5.06 |
| Brewer's Spent-Grain | 45 | 14.24 |
| Based Protein Powder | | |
| Raisins | 30 | 9.49 |
| Vanilla Extract | 6 | 1.90 |
| Barley Fiber | 15 | 4.75 |
| Total | 316 | 100 |

The above table relates to a recipe for a prototype protein bar enhanced with brewer's spent-grain based protein powder and barley fiber that can also be recovered from a conventional brewing process. In this embodiment, dates and raisins are chopped and combined with oats. The mixture is then softened. The ingredients are then mixed and gently kneaded together until uniformly blended. The product is then formed and cut to bars.

### Example 8: Protein-Enhanced Chocolate Granola Bar

| | | Approx. |
|---|---|---|
| Ingredient | Formula-g | Formula Dried % |
| Quick Oats | 68 | 27.76 |
| Puffed Rice | 18 | 7.35 |
| Vegetable Oil | 18 | 7.35 |
| Corn Syrup | 35 | 14.29 |
| Brown Sugar | 30 | 12.24 |
| Water | 16 | 6.53 |
| Brewer's Spent-Grain | 33 | 13.47 |
| Based Protein Powder | | |
| Cinnamon | 3 | 1.22 |
| Vanilla Extract | 8 | 3.27 |
| Cocoa-light Dutch 22-24% fat | 16 | 6.52 |
| Total | 245 | 100 |

The above table relates to a recipe for a chocolate granola bar enhanced with 33 g of brewer's spent-grain based protein powder. Brewer's spent-grain based protein powder is combined with cinnamon, cocoa, vanilla, oil with syrup, brown sugar, and water. Oats and rice are added and the mixture is mixed gently until blended and uniform. The mixture is then heated at 300° F. for 15 minutes and then gently stirred before it is baked for an additional 15 minutes at 300° F. The product is then cooled and stored in a closed container.

### Example 9: Chain Tea Beverage

Chai Tea Base

| Ingredient | Formula-g | Formula-% |
|---|---|---|
| Instant tea (Lipton) | 10 | 16.67 |
| Masala (chai flavor) | 3 | 5.00 |
| Sucrose | 31 | 51.66 |
| Stevia Sweetener | 16 | 26.67 |
| Total | 60 | |

Addition per 12 oz beverage-7.5 g

Protein enhanced Chai Tea

| Ingredient | Formula-g | Formula-% |
|---|---|---|
| Brewer's Spent-Grain | 64 | 51.62 |
| Based Protein Powder | | |
| Instant tea (Lipton) | 10 | 8.06 |
| Masala (chai flavor) | 3 | 2.42 |
| Sucrose | 31 | 25.0 |
| Stevia Sweetener | 16 | 12.90 |
| Total | 124 | 100 |

Addition per 12 oz beverage-15.5 g

Protein Enhanced Milk Chai Tea

| Ingredient | Formula-g | Formula-% |
|---|---|---|
| Brewer's Spent-Grain | 64 | 32 |
| Based Protein Powder | | |
| Instant tea (Lipton) | 10 | 5 |
| Nonfat dry milk | 75 | 37.5 |
| Masala (chai flavor) | 3 | 1.5 |
| Sucrose | 32 | 16 |
| Stevia Sweetener | 16 | 8 |
| Total | 200 | 100 |

Addition per 12 oz beverage-25 g

The above tables are for recipes for both conventional and protein-enhanced chai teas. Generally, the dry ingredients are added to the liquid and blended until uniform.

### Example 10: Protein Enhanced Peanut Butter Chocolate Chew

Protein Enhanced Peanut Butter Chocolate Chew

| | | % Protein |
|---|---|---|
| | | (% of total |
| Ingredient | Formula % | formula) |
| Quick Oats | 10.13 | 1.33 |
| Crisp Rice | 10.13 | 0.65 |
| Peanut Butter, Natural | 26.80 | 5.31 |
| Corn Syrup | 6.53 | |
| Light Brown Sugar | 5.23 | |
| Brewer's Spent-Grain | 21.24 | 13.81 |
| Based Protein Powder | | |
| Water | 5.23 | |
| Semi Sweet Chocolate-Melted | 14.71 | |
| Total | 100 | 21.1 |

Bar weight-37 g provide 7.8 g protein (5.1 g from Brewer's Spent-Grain Based Protein Powder)

The above table relates to a recipe for a peanut butter chocolate chew enhanced with brewer's spent-grain based protein powder. The quick oats, crisp rice and brown sugar are combined. Next, the corn syrup, warmed peanut butter and water are gently added and combined. Next, the brewer's spent-grain based protein powder is added and blended until uniform. The blended ingredients are heated gently to maintain softness and then shaped into bars or other desired shapes. The bars/other shapes are then topped with the chocolate.

### Example 11: Protein Enhanced Chocolate Taffy

Protein Enhanced Chocolate Taffy

| | | | % Protein |
|---|---|---|---|
| | | | (% of total |
| Ingredient | Formula-g | Formula % | formula) |
| Dark Chocolate | 253 | 60.38 | 0 |
| Brewer's Spent-Grain | 101 | 24.11 | 15.67 |
| Based Protein Powder | | | |
| Water | 30 | 7.16 | 0 |
| Nonfat Dry Milk | 30 | 7.16 | 2.51 |
| Sucrose | 5 | 1.19 | 0 |
| Total | 419 | 100 | 18.18 |

Each taffy piece provides approximately 4.5 g protein

The above table relates to a recipe for chocolate taffy. The chocolate is combined at a with the brewer's spent-grain based protein powder at a ration of 75/25 chocolate to protein powder. The combination is heated slowly to melt the chocolate followed by mixing until blended and uniform. Additional chocolate is added until the chocolate to protein powder ratio is 85/15. The combination is reheated and mixed. The remaining brewer's spent-grain based protein powder and the water are mixed into the combination. The combination is heated to soften and the sucrose and milk are added. The combination is mixed and shaped into pieces of about 24-25 grams.

### Example 12: Protein Enhanced Chocolate

Protein Enhanced Chocolate

| | | % Protein |
|---|---|---|
| | | (% of total |
| Ingredient | Formula % | formula) |
| Dark Chocolate | 75 | 3.5 |
| Brewer's Spent-Grain | 25 | 16.25 |
| Based Protein Powder | | |

Candy Pieces-14 g (2.3 g protein from Brewer's Spent-Grain Based Protein Powder)

The above table relates to a recipe for chocolate pieces. The chocolate and brewer's spent-grain based protein powder are combined and slowly heated to melt the chocolate. The combination is mixed and until well blended and uniform. The combination is reheated and remixed and then poured into a mold. The molded pieces are cooled under circulating air and finished under refrigeration.

### Example 13: Protein Enhanced Beverages

Protein Enhanced Beverages

| | Brewer's Spent- | | Brewer's Spent- | |
|---|---|---|---|---|
| | Grain Based Protein | | Grain Based Protein | |
| | Powder + Dairy Proteins | | Powder + Pea Protein | |
| | Formu- | Formu- | Formu- | Formu- |
| Ingredient | la - g | la % | la - g | la % |
| Brewer's Spent- | 10 | 26.54 | 14 | 38.48 |
| Grain Based | | | | |
| Protein Powder | | | | |
| WPI 90 | 10 | 26.54 | | |
| MPC 85 | 9.5 | 25.22 | | |
| Pea Protein | | | 13 | 35.73 |
| Isolate | | | | |
| Sugar | 5 | 13.27 | 5 | 13.74 |
| Cocoa | 3 | 7.96 | 4 | 11.00 |
| Stevia | 0.075 | 0.20 | 0.08 | 0.22 |
| Vanilla | | | 0.2 | 0.55 |
| Xanthan | 0.1 | 0.27 | 0.1 | 0.27 |
| Total | 37.675 | 100 | 36.38 | 100 |

The above table relates to a recipe for protein enhanced beverages. All ingredients are mixed together. The mixed ingredients are added to water and stirred.

### Example 14: Protein Enhanced Snack Bars

Protein Enhanced Snack Bars

| Ingredient | (%) | grams |
|---|---|---|
| Protein Syrup | | |
| High Maltose Corn Syrup (Malt Products Corp) | 47.80 | 57.40 |
| Granulated Sugar (Domino) | 13.00 | 15.60 |
| Salt (Morton) | 0.70 | 0.80 |
| Canola Oil (Wesson) | 4.40 | 5.30 |
| Lecithin (Cargill Hi Top) | 0.70 | 0.80 |
| Vanilla Extract (McCormick) | 1.40 | 1.70 |
| Brewer's Spent-Grain Based Protein Powder | 32.00 | 38.40 |
| (P500, 67% protein) | | |
| Total | 100.00 | 120.00 |
| Bar | | |
| Rolled Oats (Quaker Old Fashioned) | 25.00 | 56.30 |
| Rice Crisps - large | 6.50 | 14.63 |
| Rice Crisps - small | 5.00 | 11.25 |
| Protein Syrup (per above) | 51.50 | 115.82 |
| Chocolate Chips (Ghirardelli miniature) | 12.00 | 27.00 |
| Total | 100.00 | 225.00 |

5 g protein per 45 g bar

The above table relates to a recipe for protein enhanced snack bars. The oats and rice crisps are added to a mixing bowl. The chocolate is chilled in a freezer. The brewer's spent-grain based protein powder is dissolved in water in 1:1 ratio by weight while mixing. Corn syrup is heated in a small saucepan to 150° F. over low heat. The sugar and salt are added to the corn syrup and whisked to dissolve. The protein solution is added to the corn syrup and whisked to mix while heating to 87 degrees brix (+/−0.5 degrees). The corn syrup mixture is added into the oats and rice crisps and mixed at low speed. The chilled chocolate is added and mixed into the mixture. The resulting dough is rolled, cut and wrapped.

### Example 15: Protein Enhanced Macaroni and Cheese

Protein Enhanced Macaroni and Cheese

| Ingredient | Formula - g | Formula % |
|---|---|---|
| Butter, unsalted | 60 | 12.50 |
| Milk, 2% | 150 | 31.25 |
| Cheese packet, Kraft | 60 | 12.50 |
| Macaroni, Kraft | 150 | 31.25 |
| Brewer's Spent-Grain | 60 | 12.50 |
| Based Protein Powder | | |
| Total | 480 | 100 |

The above table relates to a recipe for protein enhanced macaroni and cheese. 6 cups of water are brought to boil in a large pot. The macaroni is added to the boiling water for 8-10 minutes until tender and then the macaroni is strained. The butter is melted with the milk. The brewer's spent-grain based protein powder and cheese packet are each added to the butter/milk mixture and stirred until homogenous. The strained macaroni is added to the cheese mixture and stirred.

### Example 16: Protein Enhanced Chocolate Brownie

Protein Enhanced Chocolate Brownie

| Ingredient | Formula - g | Formula % |
|---|---|---|
| Chocolate, unsweetened | 85 | 12.37 |
| Butter, unsalted | 115 | 16.74 |
| Eggs | 128 | 18.63 |
| Sugar, granulated | 265 | 38.57 |
| Vanilla extract | 5 | 0.73 |
| Sea salt, flaked | 2 | 0.29 |
| Flour, all purpose | 83 | 12.08 |
| Brewer's Spent-Grain | 4 | 0.58 |
| Based Protein Powder | | |
| Total | 687 | 100 |

The above table relates to a recipe for a protein enhanced chocolate brownie. The oven is pre-heated to 350° F. A 8×8 inch pan is covered with parchment paper, whereby butter or non-stick spray is put onto the parchment paper. The butter and chocolate are melted and stirred together. The sugar, eggs, vanilla and salt are whisked into the melted butter and chocolate mixture. In a separate bowl, the flour and brewer's spent-grain based protein powder are mixed until uniform. The dry mixture is added into the heated liquid mixture and mixes. The resulting batter is poured into the pan and baked for 25-30 minutes.

### Example 17: Protein Enhanced Tomato Sauce

Protein Enhanced Tomato Sauce

| Ingredient | Formula - g | Formula % |
|---|---|---|
| Onion finely diced | 60 | 6.53 |
| Butter, unsalted | 29 | 3.16 |
| Oregano, dried | 0.5 | 0.05 |
| Garlic clove, finely diced | 6 | 0.65 |
| Salt, iodized | 3 | 0.33 |
| Sugar | 1 | 0.11 |
| Crushed tomatoes | 794 | 86.40 |
| Olive oil | 14 | 1.52 |
| Basil, dried | 2 | 0.22 |
| Brewer's Spent-Grain | 1.5 | 0.16 |
| Based Protein Powder | | |
| Garbanzo bean flour | 8 | 0.87 |
| Total | 919 | 100 |

The above table relates to a recipe for a protein enhanced tomato sauce. The butter is melted in a saucepan over medium heat. The onions are added and sautéed for 2 minutes. The oregano and salt are added while stirring and cooking occurs until the onions begin to brown. The garlic is added and sautéed for 30 seconds. The crushes tomatoes and sugar are added and brought to a simmer for 10 minutes. The pan is removed from heat and the olive oil, basil, brewer's spent-grain based protein powder and bean flour are added and stirred until homogenous. The sauce is served over cooked pasta.

### Example 18: Protein Enhanced Red Pepper Hummus

Protein Enhanced Red Pepper Hummus

| Ingredient | Formula - g | Formula % |
|---|---|---|
| Garbanzo beans | 454 | 68.68 |
| Red bell pepper | 75 | 11.35 |
| Tahini | 15 | 2.27 |
| Lemon Juice | 25 | 3.78 |
| Water | 50 | 7.56 |
| Salt | 3 | 0.45 |
| Garlic powder | 1 | 0.15 |
| Cayenne powder | 0.5 | 0.08 |
| Black pepper | 0.5 | 0.08 |
| Brewer's Spent-Grain | 37 | 5.60 |
| Based Protein Powder | | |
| Total | 661 | 100 |

The above table relates to a recipe for protein enhanced red pepper hummus. The ingredients are all combined in a food processor and blended until desired consistency. Additional water can be added. The resulting hummus is served with chips, crackers, etc.

Various embodiments related to brewer's spent-grain based protein powders and their related use in protein-enhanced foodstuff have been described herein. These embodiments are given only by way of example and are not intended to limit the scope of the claimed inventions. It should be appreciated, moreover, that the various features of the embodiments that have been described may be combined in various ways to produce numerous additional embodiments within the contemplation of a person of ordinary skill in the art. Moreover, while various materials, dimensions, shapes, configurations and locations, etc. have been described for use with disclosed embodiments, others besides those disclosed may be utilized without exceeding the scope of the claimed inventions.

1. A protein-enhanced foodstuff comprising:
a brewer's spent-grain based protein powder having a PDCAAS of about 0.7.

2. The protein-enhanced foodstuff of claim 1, wherein the brewer's spent-grain based protein powder has a protein digestibility score of 1.0

3. The protein-enhanced foodstuff of claim 2, wherein the brewer's spent-grain based protein powder has an amino acid score of about 0.7.

4. The protein-enhanced foodstuff of claim 3, further comprising:
a supplemental amount of lysine such that the PDCAAS exceeds 0.7.

5. The protein-enhanced foodstuff of claim 1, wherein the foodstuff comprises a dry foodstuff and wherein the brewer's spent grain based protein powder is present at up to 50% by weight of the dry foodstuff.

6. The protein enhanced foodstuff of claim 5, wherein the brewer's spent-grain based protein powder is present in an amount from about 20% to about 40% by weight of the dry foodstuff.

7. The protein enhanced foodstuff of claim 1, wherein the foodstuff comprises a liquid foodstuff and wherein the brewer's spent-grain based protein powder is present in an amount of up 50% by weight of a liquid solution.

8. The protein enhanced foodstuff of claim 7, wherein the brewer's spent-grain based protein powder is present in the liquid solution in an amount from about 30% to about 40% by weight of the liquid solution.

9. The protein enhanced foodstuff of claim 7, wherein the liquid solution has a pH of less than 4.5.

10. The protein enhanced foodstuff of claim 7, wherein the liquid solution has a pH of greater than 4.5.

11. The protein enhanced foodstuff of claim 7, wherein the brewer's spent-grain based protein powder is mixed into the liquid solution at time of consumption.

12. The protein enhanced foodstuff of claim 7, wherein the brewer's spent-grain based protein powder is mixed into the liquid solution at a time of packaging such that the liquid solution has an extended storage period.

13. The protein enhanced foodstuff of claim 7, wherein the liquid solution comprises an aqueous solution.

14. The protein enhanced foodstuff of claim 1, wherein the brewer's spent-grain based protein powder has an average molecular weight of between about 500 to about 15,000 Daltons.

15. The protein enhanced foodstuff of claim 1, wherein the brewer's spent-grain based protein powder has a primary peak corresponding to about 4,200 Daltons when analyzed under liquid chromatography.

16. A method for preparing a protein enhanced foodstuff, comprising:
formulating a foodstuff; and
adding a brewer's spent-grain based protein powder to the foodstuff, wherein the brewer's spent-grain based protein has a PDCAAS of about 0.7.

17. The method of claim 16, wherein the brewer's spent-grain based protein powder has a protein digestibility score of 1.0

18. The method of claim 17, wherein the brewer's spent-grain based protein powder has an amino acid score of about 0.7.

19. The method of claim 16, further comprising:
adding a supplemental amount of lysine to the brewer's spent-grain based protein powder such that the PDCAAS exceeds 0.7.
